(19) United States
(12) Patent Application Publication
(10) Pub. No.: US 2005/0077328 A1
(43) Pub. Date: Apr. 14, 2005

(54) Weighted fish stringer

(76) Inventor: Boyd R. Perttu, Woodbury, MN (US)

Correspondence Address: MOORE, HANSEN & SUMNER, PLLP, 225 SOUTH SIXTH ST, MINNEAPOLIS, MN, 55402, US

(21) Appl. No.: 10/686,003

(22) Filed: Oct. 14, 2003

(51) Int. Cl. A01K 1/00

(52) U.S. Cl. 224/103

(57) ABSTRACT

A weighted retaining member for use with a stringer of the type used to secure fish that have been caught. The retaining member comprises a body in the general configuration of an animal or fish body, a fish configuration typically having a mouth and a tail. The body is configured to be operatively connected to a fish stringer such that the body is suspended from the stringer and hangs in the natural orientation of a fish. The retaining member may also be pre-configured as a fish stringer having the retainer already attached to one end of the stringer. When the retaining member is suspended from a fish stringer in proximity to free-swimming fish, the retaining member is accepted as a part of the natural surroundings and, accordingly, may be used in proximity to a fishing lure without driving fish away. The retaining member is weighted sufficiently to keep fish retained on the stringer under water.

### BACKGROUND AND SUMMARY OF THE INVENTION

When fishing, a fisherman typically fishes in one or more locations, moving from place to place along a riverbank, bridge, dock, pier, or shoreline, or while trolling in a boat. A problem arises in keeping caught fish alive and healthy while the fisherman continues to fish. In order to breathe, the caught fish must be completely submerged. Floating at the surface, or being dragged at the surface, as while trolling, will cause gill or other damage in already distressed fish. In non-weighted fish stringers, caught fish are simply retained on a free-floating line. The weight of the caught fish is not sufficient to keep them submerged, as dead or injured fish will float. The present fish stringer retaining member is configured to solve two problems: the need to keep caught and retained fish submerged during stationary fishing and while trolling; and the need for a weighted member configured so as not to drive away fish of the size sought by the fisherman.

The present invention is a weighted retaining member for use with a stringer of the type used to secure fish that have been caught, keeping the retained fish fully submerged by the weight of the retaining member in the body of water being fished as they are retained on the stringer. The retaining member comprises a body in the general configuration of an animal or fish body, a fish configuration typically having a mouth and a tail. The body is configured to be operatively connected to a stringer such that the body is suspended from the stringer and hangs in a natural orientation of a fish or other animal to be found in the water near fish. The retaining member is accepted by fish as a part of the natural surroundings and may be used in proximity to a fishing lure without driving fish away. The retaining member is of a weight sufficient to pull and hold the caught fish under water, both while stationary and while in trolling motion.

In a preferred embodiment, the present invention may also be configured as a fish stringer having the retainer already pre-attached to one end of the stringer.

### BRIEF DESCRIPTION OF THE DRAWINGS

FIG. 1 shows a preferred embodiment of a retaining member coupled to a cord-like member to form a fish stringer.

FIG. 2 illustrates a fish stringer in use.

### DESCRIPTION OF THE PREFERRED EMBODIMENTS

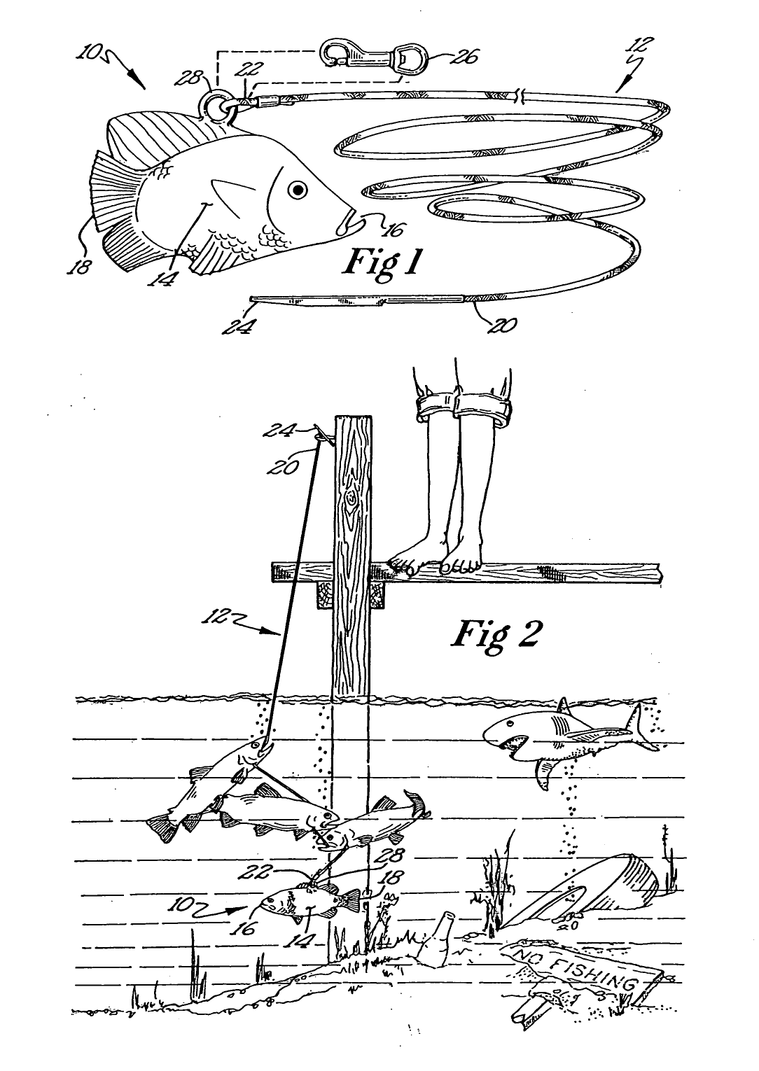

FIG. 1 shows a retaining member 10 for use with a fish stringer having a cord-like member 12 of the type used to secure fish that have been caught while fishing. Retaining member 10 comprises a body 14 in the general configuration of an animal such as a fish body having a mouth 16 and a tail 18. Body 14 is configured to be operatively connected to a conventional fish stringer or other cord-like member 12 such that body 14 is suspended from the stringer or other cord-like member and hangs in a natural orientation, such as in the swimming position of a fish. Because it is shaped in the form of an animal or fish, the retaining member 10 is accepted by fish as a part of the natural surroundings and may be used in proximity to a fishing lure without driving fish away.

As shown in the preferred embodiment of FIG. 1, retaining member 10 is configured integrally to a fish stringer having a cord-like member 12 with an insertion end 20 and a retaining end 22. A rigid insertion member, tool or needle 24 is typically coupled to the insertion end 20 of the cord-like member to facilitate passing the insertion end of the cord-like member through the gills or mouth of the body of a fish. Retaining member 10 is shown coupled to the retaining end of cord-like member 12. Insertion member, tool or needle 24 may be crimped around cord-like member 12 or may otherwise be attached to the insertion end 20 of the cord-like member.

Retaining member 10 has sufficient size to prevent a retained fish, when strung onto cord-like member 12, from falling off of the retaining end 22 of the cord-like member.

The retaining member has the approximate shape and size of a fish or other animal and is made in a size commensurate with smaller fish so as to avoid spooking fish of the size sought by the fisherman. Retaining member 10 is suspended from the retaining end 22 of the cord-like member in a substantially upright position in a natural orientation of a fish or other animal. Because of the fish-like appearance of the retaining member, fish swimming in proximity to the retaining member or the stringer will not be spooked away by the retaining member.

Retaining member 10 typically has sufficient weight to pull the retaining end of the cord-like member underwater and may have, for example, a weight in the range of about ½ to 5 pounds. The weight of retaining member 10 is sufficient to keep the retained fish under water. For purposes of the present application, the sufficient weight of the retaining member to retain the caught fish under water may be integral to the retaining member, or the integral weight of the retaining member may be increased to sufficient weight by adding one or more supplementary weights, such as one or more weights coupled directly to the retaining member, or one or more supplemental weights strung down the cord-like member of the fish stringer, with such supplemental weights strung on the cord-like member resting above and being supported by the retaining member.

Retaining member 10 may be formed of a metal casting in the shape of a fish or animal to be found in waters to be fished. However, the retaining member may also be formed of other materials, weighted sufficiently to pull the retaining end of the cord-like member under water. Cord-like member 12 may be a braided rope, a plastic-covered cable, or other cord-like material suitable for retaining fish strung onto it. Typically, retaining member 10 has a substantially non-reflective surface, which may be painted or otherwise colored as desired.

A coupling portion 28 may be configured integrally to the retaining member, or a separate coupler 26 may be attached to the retaining member for securing the retaining member to the retaining end of the cord-like member or stringer. Cord like member 12 may be secured to the retaining member in any suitable manner, including passing the retaining end of the cord-like member through an aperture defined by a portion of the retaining member.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

1. A fish stringer for retaining fish which are caught while fishing, the stringer comprising:
a cord-like member having an insertion end and a retaining end;
a rigid insertion member coupled to the insertion end of the cord-like member to facilitate passing the insertion end of the cord-like member through a body of a retained fish;
a retaining member coupled to the retaining end of the cord-like member; and
the retaining member having sufficient size to prevent the retained fish, when strung onto the cord-like member, from falling off of the retaining end of the cord-like member; and
the retaining member having the approximate shape and size of a fish and being suspended from the retaining end of the cord-like member in a substantially upright position in a natural orientation of a fish;
whereby the retained fish will be kept underwater, and fish swimming in proximity to the stringer will not be spooked away by the retaining member.

2. The stringer of claim 1 wherein the retaining member has sufficient integral weight to pull the retaining end of the cord-like member under water and to keep the retained fish under water.

3. The stringer of claim 1 wherein the retaining member comprises a coupling portion configured for attachment to the retaining end of the cord-like member.

4. The stringer of claim 3 wherein the coupling portion comprises an aperture defined by a portion of the retaining member.

5. A stringer for retaining a fish that has been caught while fishing, the stringer comprising:
a flexible cord-like member having a first end and a second end;
an insertion tool operatively connected to the first end of the cord-like member, the insertion tool being configured to pass through the body of a retained fish; and
a retaining member being operatively connected to the second end of the cord-like member, the retaining member having sufficient size to prevent a fish that has been threaded onto the cord-like member from passing beyond the retaining member, the retaining member having sufficient weight to hold the retained fish underwater, the retaining member being arranged and configured to blend in with surroundings in which it is placed;
whereby the retained fish will be kept underwater, and free-swimming fish will accept the retaining member as a part of the natural surroundings so that the stringer may be used in proximity to a fishing lure without driving fish away.

6. The stringer of claim 5, wherein the retaining member is in the shape of an animal.

7. The stringer of claim 5, wherein the retaining member is in the shape of a fish.

8. The stringer of claim 5, wherein the retaining member has sufficient integral weight to hold the retained fish under water.

9. The stringer of claim 1, wherein the retaining member has a substantially non-reflective surface.

10. A retaining member for use with a stringer of the type used to secure fish that have been caught, the retaining member comprising:
a body in the general configuration of a fish body having a mouth and a tail, the body being configured to be operatively connected to a stringer such that the body is suspended from the stringer and hangs in a natural orientation of a fish;
whereby fish will accept the retaining member as a part of the natural surroundings and the stringer may be used in proximity to a fishing lure without driving fish away.

11. The retaining member of claim 10 wherein the retaining member has sufficient integral weight to keep fish retained on the stringer under water.

12. The retaining member of claim 10 comprising a coupling portion configured for attachment to a stringer.

13. The retaining member of claim 12 wherein the coupling portion comprises an aperture defined by a portion of the retaining member.

14. The stringer of claim 13, wherein the retaining member has a substantially non-reflective surface.
